(19) United States
(12) Patent Application Publication
(10) Pub. No.: US 2026/0369747 A1
(43) Pub. Date: Nov. 19, 2026

(54) ZINC-AIR BATTERY WITH INTEGRATED ELECTRODE ARCHITECTURE AND ULTRA-THIN FLOWABLE CATHOLYTE

(71) Applicant: UNIVERSITY OF CONNECTICUT, Farmington, CT (US)

(72) Inventors: Xiao-Dong Zhou, Columbia, CT (US); Nengneng Xu, Vernon, CT (US)

(21) Appl. No.: 19/673,034

(22) Filed: May 11, 2026

Related U.S. Application Data
(60) Provisional application No. 63/802,853, filed on May 9, 2025.
(60) Provisional application No. 63/802,858, filed on May 9, 2025.

(51) Int. Cl. H01M 12/08; H01M 4/86; H01M 4/90; H01M 8/18

(52) U.S. Cl. CPC H01M 12/08; H01M 4/8605; H01M 4/8652; H01M 4/9016; H01M 4/9041; H01M 8/18; H01M 2004/8684; H01M 2004/8689; H01M 2300/002

(57) ABSTRACT

A zinc-air flow battery includes a battery housing defining a cathode compartment and an anode compartment, a porous separator between the cathode compartment and the anode compartment, an integrated cathode in the cathode compartment, and a nickel or a titanium mesh current collector in the anode compartment. The integrated cathode includes a conductive porous substrate and a nickel-, cobalt-, and manganese-containing catalyst directly grown on the conductive porous substrate such that the integrated cathode is self-supported and binder-free. A gas diffusion layer is pressed against the conductive porous substrate. A flowable catholyte including potassium hydroxide is disposed between the integrated cathode and the porous separator and forms, with the integrated cathode, a three-dimensional gas-liquid-solid reaction environment. A flowable anolyte including potassium hydroxide and zinc oxide contacts the nickel or titanium mesh current collector, and a zinc anode is electrochemically deposited on the nickel or titanium mesh current collector.

### CROSS REFERENCE TO RELATED APPLICATIONS

This application claims the benefit of and priority to U.S. Patent Application Nos. 63/802,853 and 63/802,858, each of which was filed on May 9, 2025, the contents of each of which are incorporated by reference herein in their entirety for all purposes.

### BACKGROUND OF THE INVENTION

### 1. Field of the Invention

The present disclosure relates to zinc-air batteries and, more particularly, to zinc-air batteries including an integrated electrode architecture paired with an ultra-thin flowable catholyte.

### 2. Description of the Related Art

Metal-air batteries, including zinc-air batteries, are of interest for energy storage applications because they can use oxygen from ambient air as an electrochemical reactant and can provide relatively high theoretical energy density. Zinc-air batteries can also benefit from the abundance and relatively low cost of zinc, making such batteries relevant to applications ranging from portable power sources to larger-scale energy storage systems.

Rechargeable zinc-air batteries can present technical challenges that can limit practical performance. Air electrodes are to support oxygen reduction during discharge and oxygen evolution during charge while maintaining sufficient catalytic activity, electrical conductivity, gas transport, and mechanical stability over repeated cycling. In addition, zinc electrodes and alkaline electrolytes can be affected by nonuniform zinc deposition, dendrite formation, corrosion, electrolyte management issues, and mass-transport limitations, particularly at high current densities or during long-term cycling.

Accordingly, what are needed are new structure and methods in connection with zinc-air batteries, which can support increased power output, improved rechargeability, effective oxygen utilization, and/or stable operation over extended charge-discharge cycling.

### SUMMARY OF THE INVENTION

In one aspect, the present teachings generally provide a zinc-air flow battery that can include a battery housing defining a cathode compartment and an anode compartment; a porous separator positioned between the cathode compartment and the anode compartment; an integrated cathode disposed in the cathode compartment, the integrated cathode including a conductive porous substrate and a catalyst directly grown on the conductive porous substrate such that the integrated cathode is self-supported and binder-free, where the catalyst includes nickel, cobalt, and manganese and where Mn(III) is present as a predominant manganese species based on manganese species present in the catalyst; a gas diffusion layer pressed against the conductive porous substrate, the gas diffusion layer including carbon fiber paper and/or carbon fiber cloth and catalytic metal particles and/or catalytic metal oxide particles disposed on the carbon fiber paper and/or the carbon fiber cloth; a flowable catholyte including KOH disposed in the cathode compartment between the integrated cathode and the porous separator, where the flowable catholyte and the integrated cathode define a three-dimensional gas-liquid-solid reaction environment; a nickel or titanium mesh current collector disposed in the anode compartment; a flowable anolyte including KOH and ZnO disposed in the anode compartment and in contact with the nickel or titanium mesh current collector; and a zinc anode electrochemically deposited on the nickel or titanium mesh current collector.

In some embodiments, the zinc-air flow battery includes a conductive porous substrate that includes nickel foam. In some embodiments, the zinc-air flow battery has a catalyst that includes nickel oxide, cobalt oxide, and manganese oxide. In some embodiments, the zinc-air flow battery has Mn(III) present in an amount greater than 50 atomic percent based on total manganese oxidation states present in the catalyst. In certain embodiments, the catalyst includes manganese in an amount greater than 50 weight percent based on a total weight of nickel, cobalt, and manganese present in the catalyst. In some embodiments, the zinc-air flow battery has a flowable catholyte having a thickness of 1 micrometer to 4 micrometers. In some embodiments, the zinc-air flow battery includes a nickel or titanium mesh current collector having one or more of a thickness of 200 micrometers to 500 micrometers, an average pore size of 150 micrometers to 400 micrometers, and a porosity of 45 volume percent to 65 volume percent based on a total volume of the nickel or titanium mesh current collector. In some embodiments, the zinc-air flow battery housing defines a catholyte channel to provide controlled flow of the flowable catholyte and an anolyte channel to provide controlled flow of the flowable anolyte. In some embodiments, the zinc-air flow battery includes catalytic metal particles and/or catalytic metal oxide particles including at least one of manganese oxide, cobalt oxide, silver, platinum, and another transition metal-based catalyst. In some embodiments, the zinc-air flow battery has a gas diffusion layer that defines a hydrophilic-hydrophobic interface to reduce leakage through the conductive porous substrate.

In one aspect, the present teachings generally provide an integrated cathode for a zinc-air flow battery, the integrated cathode including a conductive porous substrate defining open gas diffusion channels; a catalyst directly grown on the conductive porous substrate such that the integrated cathode is self-supported and binder-free, where the catalyst includes nickel, cobalt, and manganese and where Mn(III) is present as a predominant manganese species based on manganese species present in the catalyst; and a gas diffusion layer pressed against the conductive porous substrate, the gas diffusion layer including carbon fiber paper and/or carbon fiber cloth and catalytic metal particles and/or catalytic metal oxide particles disposed on the carbon fiber paper and/or the carbon fiber cloth.

In some embodiments, the integrated cathode has a conductive porous substrate that includes nickel foam. In some embodiments, the integrated cathode has a catalyst that includes nickel oxide, cobalt oxide, and manganese oxide. In some embodiments, the integrated cathode has Mn(III) present in an amount greater than 50 atomic percent based on total manganese oxidation states present in the catalyst. In some embodiments, the integrated cathode has a catalyst that includes manganese in an amount greater than 50 weight percent based on a total weight of nickel, cobalt, and manganese present in the catalyst. In some embodiments, the integrated cathode has catalytic metal particles and/or catalytic metal oxide particles that include at least one of manganese oxide, cobalt oxide, silver, platinum, and another transition metal-based catalyst. In some embodiments, the integrated cathode has catalytic metal particles and/or catalytic metal oxide particles that are dispersed on a high-surface-area conductive support. In some embodiments, the integrated cathode has a gas diffusion layer that includes an ion-conducting binder holding the catalytic metal particles and/or catalytic metal oxide particles on the carbon fiber paper and/or the carbon fiber cloth. In some embodiments, the integrated cathode has a catalyst directly grown on the conductive porous substrate to form a three-dimensional architecture having exposed active sites and continuous electron pathways through the conductive porous substrate.

In one aspect, the present teaching generally provide a method of manufacturing a zinc-air flow battery, the method including disposing metal oxides, salts of catalytic metals, or a combination thereof on a conductive porous substrate, where the salts of catalytic metals include at least one of nickel salts, cobalt salts, and manganese salts; annealing the conductive porous substrate to directly grow a catalyst on the conductive porous substrate such that an integrated cathode including the conductive porous substrate and the catalyst is self-supported and binder-free; disposing catalytic metal particles and/or catalytic metal oxide particles on carbon fiber paper and/or carbon fiber cloth to form a gas diffusion layer; pressing the gas diffusion layer against the conductive porous substrate; positioning a porous separator between the integrated cathode and a nickel or titanium mesh current collector; disposing a flowable catholyte including KOH between the integrated cathode and the porous separator such that the flowable catholyte and the integrated cathode define a three-dimensional gas-liquid-solid reaction environment; disposing a flowable anolyte including KOH and ZnO between the porous separator and the nickel or titanium mesh current collector; and electrochemically depositing a zinc anode onto the nickel or titanium mesh current collector.

In one aspect, the present disclosure provides a method of using a zinc-air flow battery, where the method generally includes providing a zinc-air flow battery including a battery housing defining a cathode compartment and an anode compartment, a porous separator positioned between the cathode compartment and the anode compartment, an integrated cathode disposed in the cathode compartment, a gas diffusion layer pressed against the integrated cathode, a nickel or titanium mesh current collector disposed in the anode compartment, a flowable catholyte including KOH disposed in the cathode compartment, and a flowable anolyte including KOH and ZnO disposed in the anode compartment, where the integrated cathode includes a conductive porous substrate and a catalyst directly grown on the conductive porous substrate such that the integrated cathode is self-supported and binder-free, where the catalyst includes nickel, cobalt, and manganese and where Mn(III) is present as a predominant manganese species based on manganese species present in the catalyst; flowing the flowable catholyte through the cathode compartment such that the flowable catholyte contacts the integrated cathode and defines, with the integrated cathode, a three-dimensional gas-liquid-solid reaction environment; flowing the flowable anolyte through the anode compartment such that the flowable anolyte contacts the nickel or titanium mesh current collector; supplying an oxygen-containing gas to the gas diffusion layer; charging the zinc-air flow battery to electrochemically deposit a zinc anode on the nickel or titanium mesh current collector; and discharging the zinc-air flow battery by oxidizing zinc of the zinc anode in the anode compartment and reducing oxygen at the integrated cathode in the cathode compartment.

In one aspect, the present disclosure provides an electrochemical storage system including a zinc-air battery, the zinc-air battery including a battery housing defining a cathode compartment and an anode compartment; a porous separator positioned between the cathode compartment and the anode compartment; an integrated cathode disposed in the cathode compartment, the integrated cathode including a conductive porous substrate and a catalyst directly grown on the conductive porous substrate such that the integrated cathode is self-supported and binder-free, where the catalyst includes nickel, cobalt, and manganese and where Mn(III) is present as a predominant manganese species based on manganese species present in the catalyst; a gas diffusion layer pressed against the conductive porous substrate, the gas diffusion layer including carbon fiber paper and/or carbon fiber cloth and catalytic metal particles and/or catalytic metal oxide particles disposed on the carbon fiber paper and/or the carbon fiber cloth; a flowable catholyte including KOH disposed in the cathode compartment between the integrated cathode and the porous separator, where the flowable catholyte and the integrated cathode define a three-dimensional gas-liquid-solid reaction environment; a nickel mesh current collector disposed in the anode compartment; a flowable anolyte including KOH and ZnO disposed in the anode compartment and in contact with the nickel or titanium mesh current collector; and a zinc anode electrochemically deposited on the nickel or titanium mesh current collector, where the electrochemical storage system is used for one or more of electrochemical energy storage, renewable energy generation and storage, grid-scale energy storage, microgrid energy storage, backup power, distributed power systems, transportation electrification, industrial power management, telecommunications power systems, and stationary battery manufacturing.

These and other features will be more clearly understood from the following drawings, detailed description and example as well as the appended claims.

### BRIEF DESCRIPTION OF THE DRAWINGS

The features and advantages of the present disclosure will be apparent from the following description taken in conjunction with the accompanying drawings.

FIG. 1 is a schematic diagram depicting an embodiment of a zinc-air battery of the present disclosure.

FIG. 2 is a schematic diagram depicting an embodiment of an integrated cathode of the zinc-air battery.

FIGS. 3A and 3B depict scanning electron microscopic (SEM) photomicrographs of integrated the cathode at different magnifications (A) at a magnification of 5000×; and (B) at a magnification of 20,000×.

FIG. 4 is a graph depicting manganese (Mn) oxidation states of catalytic metal particles of an integrated cathode.

FIGS. 5A and 5B depict the linear sweep voltammetry (LSV) curves for the integrated cathode of Example 1. FIG. 5A depicts the LSV curve for an oxygen reduction reaction (ORR), while FIG. 5B depicts the LSV curve for an oxygen evolution reaction (OER).

FIG. 6A is a Ragone plot (specific energy vs. specific power) of different battery and supercapacitor technologies, with the performance of the Zn-air flow battery developed in this work marked by red stars. FIG. 6B is a graph of maximum power output of zinc-air batteries of various sizes.

### DETAILED DESCRIPTION OF THE INVENTION

Disclosed herein are apparatuses, systems, electrodes, electrochemical cells, zinc-air flow batteries, methods of making the same, and methods of using the same for electrochemical energy storage and conversion. In some embodiments, the disclosed technology includes a zinc-air flow battery including an integrated cathode, a flowable catholyte, a porous separator, a flowable anolyte, and a current collector arranged to support electrochemical deposition of a zinc anode. The integrated cathode includes a conductive porous substrate and a catalyst directly grown on the conductive porous substrate such that the integrated cathode is self-supported and binder-free. In some embodiments, the catalyst includes nickel, cobalt, and manganese, and Mn(III) is present as a predominant manganese species based on manganese species present in the catalyst. A gas diffusion layer can be pressed against the conductive porous substrate to facilitate delivery of an oxygen-containing gas to the integrated cathode. The flowable catholyte can be disposed between the integrated cathode and the porous separator and, together with the integrated cathode, can define a three-dimensional gas-liquid-solid reaction environment. The flowable anolyte can include potassium hydroxide and zinc oxide and can contact a nickel or titanium mesh current collector on which zinc is electrochemically deposited during charging and from which zinc is oxidized during discharging.

In some battery architectures, practical performance can be limited by the need for an air electrode to support oxygen reduction during discharge and oxygen evolution during charge while maintaining catalytic activity, electrical conductivity, gas transport, electrolyte access, and mechanical stability over repeated cycling. Additional limitations can arise from restricted gas-liquid-solid reaction interfaces, inactive volume within electrode structures, transport resistance through electrolyte layers, and zinc side effects including non-uniform deposition, dendrite formation, corrosion, and electrolyte management challenges. These limitations can reduce oxygen utilization, increase internal resistance, and constrain power output and rechargeability, particularly during high-current-density or long-duration cycling operation.

The zinc-air battery disclosed herein has a number of advantages. It has an architecture that can integrate a high-performance cathode, a porous separator, and an anode based on zinc electroplating onto a nickel or titanium mesh substrate. This configuration can offer improved structural integrity, uniform zinc deposition, enhanced ionic conductivity, and/or superior cyclability compared to traditional designs. The integrated cathode can support efficient oxygen reduction reactions, while the porous separator can ensure controlled ion migration and electrolyte circulation. The titanium mesh anode can enable robust and reversible zinc plating/stripping without substantial dendrite growth, thereby significantly enhancing the battery's rechargeability and lifespan.

More specifically, advantages and technical effects of the technology disclosed herein can include improved oxygen utilization at an air cathode, increased availability of catalytic active sites, reduced cathode inactive volume, improved electron transport through a conductive porous substrate, reduced reliance on polymer binders in a cathode structure, improved gas-liquid-solid contact within a cathode compartment, and/or improved reversibility of zinc deposition and oxidation at an anode current collector. In some embodiments, the directly grown catalyst on the conductive porous substrate provides continuous electron pathways and exposed catalytic surfaces for oxygen reduction and oxygen evolution reactions. In some embodiments, the flowable catholyte reduces oxygen diffusion distance and increases contact between electrolyte, oxygen, and catalytic material. In some embodiments, the titanium mesh current collector promotes distributed zinc deposition during charging. These features can improve power density, energy density, cycling stability, and operational durability of a zinc-air flow battery relative to structures in which catalyst particles are held primarily by inactive binder or in which oxygen, electrolyte, and catalyst contact is limited to a substantially planar reaction interface.

Industries that can benefit from the technology disclosed herein include electrochemical energy storage, renewable energy generation and storage, grid-scale energy storage, microgrid energy storage, backup power, distributed power systems, transportation electrification, industrial power management, telecommunications power systems, and stationary battery manufacturing. The disclosed technology can be used in settings in which rechargeable metal-air batteries or flow batteries are used to store electrical energy, regulate intermittent power generation, provide backup power, supply peak-shaving capacity, or support long-duration discharge. The disclosed technology can also be used in laboratory, pilot-scale, or commercial manufacturing of zinc-air batteries, zinc-air flow batteries, integrated air electrodes, bifunctional oxygen electrodes, and related electrochemical devices.

Before introducing the technology in detail, some context is provided.

As used herein, “zinc-air flow battery” generally refers to an electrochemical energy storage device in which oxygen participates in one or more cathode reactions and in which at least one electrolyte is movable through or within a battery housing during operation. A zinc-air flow battery can include a non-rechargeable battery, a rechargeable secondary battery, a flow-assisted zinc-air cell, a laboratory test cell, a stackable cell, or a module including multiple cells. A zinc-air flow battery can be selected based on intended current density, discharge duration, rechargeability, electrolyte composition, gas supply configuration, and available packaging volume.

As used herein, “battery housing” generally refers to a structure that supports, contains, separates, or fluidically defines one or more electrochemical regions of a zinc-air flow battery. A battery housing can be formed from polymeric materials, chemically resistant plastics, elastomers, composites, ceramics, metals having corrosion-resistant coatings, or combinations thereof. Examples include acrylic housings, polycarbonate housings, polypropylene housings, polytetrafluoroethylene-containing housings, polyether ether ketone housings, and gasketed electrochemical cell fixtures available from electrochemical cell suppliers. A battery housing can be selected based on chemical compatibility with alkaline electrolyte, mechanical rigidity, sealing performance, machinability, gas permeability, and operating temperature.

As used herein, “cathode compartment” generally refers to a region of a battery housing in which an air cathode, an integrated cathode, a gas diffusion layer, a catholyte, oxygen, or a combination thereof is disposed or transported.

As used herein, “anode compartment” generally refers to a region of a battery housing in which an anode current collector, zinc, an anolyte, zinc-containing species, or a combination thereof is disposed or transported.

A cathode compartment or an anode compartment can be a channel, chamber, cavity, flow field, manifold, recessed region, or interfacial region defined by one or more housing members, seals, gaskets, spacers, or electrode surfaces.

As used herein, “porous separator” generally refers to an ion-permeable structure positioned between cathode-side and anode-side regions of an electrochemical cell to allow ionic communication while physically separating electrode structures or electrolyte regions. A porous separator can include a polymer membrane, a microporous membrane, an ion-conducting membrane, a nonwoven separator, a ceramic separator, a glass fiber separator, a cellulose-based separator, a polyolefin separator, a nylon separator, or a composite separator. Commercial examples include microporous polypropylene separators, microporous polyethylene separators, glass fiber filter separators, and alkaline battery separators. A porous separator can be selected based on ionic resistance, pore size, porosity, electrolyte wettability, chemical stability in potassium hydroxide, mechanical strength, and resistance to zinc dendrite penetration.

As used herein, “integrated cathode” generally refers to a cathode structure in which a conductive porous substrate, catalytic material, and gas diffusion layer are combined into a mechanically and electrically coupled cathode assembly. An integrated cathode can include a pressed, laminated, stacked, contacted, compressed, bonded, or otherwise assembled cathode structure. The integrated cathode can be designed to support oxygen reduction reaction activity during discharge, oxygen evolution reaction activity during charge, or both. Components of the integrated cathode can be selected based on catalytic activity, electrical conductivity, gas permeability, electrolyte accessibility, mechanical stability, corrosion resistance, and compatibility with alkaline electrolyte.

As used herein, “conductive porous substrate” generally refers to an electrically conductive body having interconnected pores, openings, voids, channels, or passages through which gas, liquid electrolyte, or both can be transported. A conductive porous substrate can include nickel foam, stainless steel mesh, titanium mesh, carbon cloth, carbon paper, carbon felt, carbon foam, metal foam, metal felt, metal mesh, expanded metal, sintered metal, conductive ceramic foam, conductive polymer composite, or a coated porous substrate. Commercial examples include nickel foam current collectors, carbon paper gas diffusion substrates, carbon cloth gas diffusion substrates, stainless steel mesh, titanium mesh, and reticulated metal foams. A conductive porous substrate can be selected based on conductivity, pore size, porosity, thickness, compressibility, corrosion resistance, catalyst-growth compatibility, and ability to define gas diffusion channels.

As used herein, “catalyst directly grown on the conductive porous substrate” generally refers to catalytic material formed, nucleated, deposited, converted, anchored, or otherwise produced on a surface of the conductive porous substrate such that the catalytic material can be in electrical communication with the conductive porous substrate. Direct growth can include thermal decomposition, annealing of precursor salts, electrodeposition, hydrothermal growth, solvothermal growth, chemical bath deposition, precipitation, oxidation, reduction, vapor deposition, atomic layer deposition, sputtering, electroless deposition, or combinations thereof. Direct growth can be selected to provide adhesion, exposed catalytic sites, electrical contact, coverage of internal pore surfaces, and reduced use of inactive binder within the catalytic region.

As used herein, “self-supported” generally refers to an electrode or electrode subassembly that can maintain an operative electrode form using a conductive porous substrate as a structural support. A self-supported electrode can be handled, positioned, pressed, assembled, or operated without requiring a separate dense current collector sheet to hold a particulate catalyst layer in place. Self-supported structures can include catalyst-coated nickel foam, catalyst-coated metal mesh, catalyst-coated carbon cloth, catalyst-coated carbon paper, catalyst-coated carbon felt, and catalyst-coated conductive foam structures. A self-supported structure can be selected based on rigidity, flexibility, thickness, pore connectivity, catalyst adhesion, and compatibility with cell compression.

As used herein, “binder-free” generally refers to an electrode region or catalytic structure in which catalytic material is not primarily immobilized by an added polymeric binder within that electrode region or catalytic structure. A binder-free structure can still be used with adjacent components that include binder, sealing material, gasket material, ionomer, or adhesive. Binder-free structures can be obtained by directly growing catalytic material on a conductive porous substrate, sintering catalytic material to a substrate, electrodepositing catalytic material, chemically depositing catalytic material, or converting precursor material on a substrate. A binder-free structure can be selected to reduce inactive volume, reduce blocked catalytic sites, improve electronic contact, or improve electrolyte access.

As used herein, “catalyst” generally refers to a material that increases a rate, efficiency, or selectivity of an electrochemical reaction without being consumed stoichiometrically by the overall cell reaction. In zinc-air flow batteries, a catalyst can promote an oxygen reduction reaction, an oxygen evolution reaction, or both. A catalyst can include nickel-containing material, cobalt-containing material, manganese-containing material, nickel oxide, cobalt oxide, manganese oxide, mixed metal oxide, spinel oxide, perovskite oxide, hydroxide, oxyhydroxide, noble metal, noble metal oxide, transition metal compound, carbon-supported catalyst, or combinations thereof. Commercial examples include manganese oxide powders, cobalt oxide powders, platinum on carbon catalysts, ruthenium oxide catalysts, iridium oxide catalysts, and transition metal oxide catalyst powders. A catalyst can be selected based on bifunctional activity, stability in alkaline electrolyte, abundance, conductivity, oxidation state, particle morphology, and compatibility with a selected substrate.

As used herein, “Mn(III)” generally refers to manganese having a +3 oxidation state in a catalyst or catalytic material. As used herein, the phrase “Mn(III) is present as a predominant manganese species” generally refers to a condition in which Mn(III) contributes more than any other individual manganese oxidation state to the manganese species detectable in the catalyst by a selected characterization technique. Such characterization techniques can include X-ray photoelectron spectroscopy, X-ray absorption spectroscopy, electron energy loss spectroscopy, X-ray diffraction used with phase analysis, electrochemical characterization correlated to reference materials, or combinations thereof. In some embodiments, Mn(III) can be present in an amount greater than 50 atomic percent based on total manganese oxidation states present in the catalyst.

As used herein, “gas diffusion layer” generally refers to a porous layer designed to transport an oxygen-containing gas toward catalytic material while supporting electrical conduction, liquid management, or mechanical support. A gas diffusion layer can include carbon fiber paper, carbon fiber cloth, carbon cloth, carbon paper, carbon felt, carbon veil, porous carbon sheet, metal mesh, metal foam, hydrophobic-treated porous material, hydrophilic-treated porous material, or combinations thereof. Commercial examples include carbon paper gas diffusion layers, carbon cloth gas diffusion layers, wet-proofed carbon paper, and carbon fiber papers supplied for fuel cells or metal-air batteries. A gas diffusion layer can be selected based on gas permeability, electrical conductivity, thickness, compressibility, wetting behavior, mechanical integrity, and compatibility with catalyst loading.

As used herein, “catalytic metal particles or catalytic metal oxide particles” generally refers to particulate catalytic material containing one or more metals, metal oxides, mixed metal oxides, metal hydroxides, metal oxyhydroxides, noble metals, transition metals, or combinations thereof. Examples include manganese oxide particles, cobalt oxide particles, nickel oxide particles, silver particles, platinum particles, ruthenium oxide particles, iridium oxide particles, spinel oxide particles, perovskite oxide particles, and mixed nickel-cobalt-manganese oxide particles. Commercial examples include platinum on carbon powder, ruthenium oxide powder, manganese dioxide powder, cobalt oxide powder, nickel oxide powder, and silver catalyst powder. Such particles can be selected based on oxygen reduction activity, oxygen evolution activity, stability, particle size, surface area, cost, and compatibility with a support or binder.

As used herein, “high-surface-area conductive support” generally refers to an electrically conductive support material having surface area available for dispersing catalytic particles. A high-surface-area conductive support can include carbon black, activated carbon, graphene, reduced graphene oxide, carbon nanotubes, carbon nanofibers, mesoporous carbon, conductive metal oxide, doped metal oxide, metal nanoparticle support, or combinations thereof. Commercial examples include Vulcan carbon black, Ketjenblack carbon, acetylene black, carbon nanotube powders, graphene nanoplatelets, and conductive carbon blacks used in electrochemical electrodes. A high-surface-area conductive support can be selected based on surface area, conductivity, corrosion resistance, particle size, pore structure, dispersibility, and compatibility with alkaline electrolyte.

As used herein, “ion-conducting binder” generally refers to a material that can hold particles on a substrate while permitting ionic transport or maintaining access to electrolyte. An ion-conducting binder can include an ionomer, alkaline-stable ionomer, anion-exchange ionomer, proton-exchange ionomer used in compatible environments, fluoropolymer dispersion, polymer electrolyte, or a mixture including a polymer and ion-conducting additive. Commercial examples include Nafion ionomer dispersions, anion-exchange ionomer dispersions, polytetrafluoroethylene dispersions used as electrode binders, and polyvinylidene fluoride binders used with ion-conducting additives. An ion-conducting binder can be selected based on chemical stability, ionic conductivity, hydrophobicity, hydrophilicity, adhesion, processability, and compatibility with the catalyst and gas diffusion layer.

As used herein, “flowable catholyte” generally refers to an electrolyte present on or near a cathode side of an electrochemical cell and capable of flowing, being pumped, being circulated, or otherwise moving through a cathode compartment or catholyte channel. A flowable catholyte can be aqueous, alkaline, gel-like, slurry-like, or multiphase, provided that the flowable catholyte can provide ionic communication with cathode-side catalytic material. A flowable catholyte can include potassium hydroxide, sodium hydroxide, lithium hydroxide, alkaline carbonate, alkaline additive, dissolved oxygen, water, zinc-containing species, stabilizing additive, wetting additive, or combinations thereof. Commercial examples include aqueous potassium hydroxide solutions prepared from reagent-grade potassium hydroxide pellets and deionized water. A flowable catholyte can be selected based on ionic conductivity, oxygen solubility, viscosity, chemical stability, carbonation tolerance, compatibility with the separator, and ability to wet the integrated cathode.

As used herein, “flowable anolyte” generally refers to an electrolyte present on or near an anode side of an electrochemical cell and capable of flowing, being pumped, being circulated, or otherwise moving through an anode compartment or anolyte channel. A flowable anolyte can include potassium hydroxide, zinc oxide, zincate species, dissolved zinc-containing species, sodium hydroxide, lithium hydroxide, water, corrosion inhibitor, dendrite-suppressing additive, viscosity modifier, or combinations thereof. Commercial examples include alkaline zincate electrolytes prepared from reagent-grade potassium hydroxide and zinc oxide. A flowable anolyte can be selected based on zinc solubility, ionic conductivity, viscosity, zinc deposition morphology, corrosion behavior, separator compatibility, and operating temperature.

As used herein, “KOH” refers to potassium hydroxide. Potassium hydroxide can be provided as pellets, flakes, powders, concentrated aqueous solutions, diluted aqueous solutions, or electrolyte solutions. Commercial examples include reagent-grade potassium hydroxide pellets, battery-grade potassium hydroxide, and standardized aqueous potassium hydroxide solutions. Potassium hydroxide concentration can be selected based on conductivity, zinc solubility, oxygen reaction kinetics, viscosity, freezing point, corrosion behavior, and compatibility with housing and separator materials.

As used herein, “ZnO” refers to zinc oxide. Zinc oxide can be provided as a powder, particulate solid, suspended material, dissolved zinc-containing species in alkaline solution, or a precursor to zincate species. Commercial examples include reagent-grade zinc oxide powder, battery-grade zinc oxide, and nanoscale zinc oxide powders. Zinc oxide amount can be selected based on desired zincate concentration, zinc deposition capacity, electrolyte viscosity, precipitation tendency, and cycling conditions.

As used herein, “nickel mesh current collector” generally refers to an electrically conductive nickel-containing mesh, screen, expanded metal, woven metal, perforated metal, or porous nickel structure to collect current and provide a surface for zinc deposition or stripping. A nickel mesh current collector can include commercially available nickel mesh, nickel expanded metal, nickel screen, nickel felt, nickel foam, nickel alloy mesh, or nickel coated with conductive or protective coatings. Selection criteria can include corrosion resistance in alkaline electrolyte, pore size, porosity, thickness, electrical resistance, mechanical strength, and ability to promote distributed zinc deposition.

As used herein, “titanium mesh current collector” generally refers to an electrically conductive titanium-containing mesh, screen, expanded metal, woven metal, perforated metal, or porous titanium structure to collect current and provide a surface for zinc deposition or stripping. A titanium mesh current collector can include commercially available titanium mesh, titanium expanded metal, titanium screen, titanium felt, titanium foam, titanium alloy mesh, or titanium coated with conductive or protective coatings. Selection criteria can include corrosion resistance in alkaline electrolyte, pore size, porosity, thickness, electrical resistance, mechanical strength, and ability to promote distributed zinc deposition.

A titanium or nickel mesh current collector can have a thickness of 50 micrometers to 500 micrometers. For example, a thickness can range from 75 micrometers to 475 micrometers, from 100 micrometers to 450 micrometers, from 125 micrometers to 425 micrometers, from 150 micrometers to 400 micrometers, from 175 micrometers to 375 micrometers, from 200 micrometers to 350 micrometers, from 225 micrometers to 325 micrometers, or from 250 micrometers to 300 micrometers.

A titanium or nickel mesh current collector can have an average pore size of 50 micrometers to 400 micrometers. For example, the average pore size can range from 50 micrometers to 400 micrometers, such as from 50 micrometers to 350 micrometers, from 50 micrometers to 300 micrometers, from 50 micrometers to 250 micrometers, from 50 micrometers to 200 micrometers, from 50 micrometers to 150 micrometers, from 50 micrometers to 100 micrometers, from 100 micrometers to 400 micrometers, from 150 micrometers to 400 micrometers, from 200 micrometers to 400 micrometers, from 250 micrometers to 400 micrometers, from 300 micrometers to 400 micrometers, from 350 micrometers to 400 micrometers, from 100 micrometers to 350 micrometers, from 150 micrometers to 300 micrometers, and from 200 micrometers to 250 micrometers.

A titanium or nickel mesh current collector can have a porosity of 45 volume percent to 75 volume percent based on a total volume of the titanium mesh current collector. For example, the porosity can range from 45 volume percent to 75 volume percent, such as from 45 volume percent to 70 volume percent, from 45 volume percent to 65 volume percent, from 45 volume percent to 60 volume percent, from 45 volume percent to 55 volume percent, from 45 volume percent to 50 volume percent, from 50 volume percent to 75 volume percent, from 55 volume percent to 75 volume percent, from 60 volume percent to 75 volume percent, from 65 volume percent to 75 volume percent, from 70 volume percent to 75 volume percent, from 50 volume percent to 70 volume percent, and from 55 volume percent to 65 volume percent.

As used herein, “zinc anode electrochemically deposited on the nickel or titanium mesh current collector” generally refers to zinc metal formed on the nickel or titanium mesh current collector by reduction of zinc-containing species during charging or another electrodeposition step. Electrochemically deposited zinc can be present as a coating, layer, deposit, particulate deposit, dendrite-suppressed deposit, porous deposit, or distributed deposit on external and internal surfaces of the nickel or titanium mesh current collector. Zinc deposition can be controlled by current density, electrolyte composition, zincate concentration, flow rate, temperature, current collector morphology, and charge protocol.

As used herein, “three-dimensional gas-liquid-solid reaction environment” generally refers to a reaction region in which gaseous reactant, liquid electrolyte, and solid catalytic material are brought into contact throughout at least a portion of a porous electrode architecture rather than only at a substantially planar surface. The gaseous reactant can include oxygen-containing gas, the liquid electrolyte can include a flowable catholyte, and the solid catalytic material can include catalyst directly grown on a conductive porous substrate or catalytic particles on a gas diffusion layer. A three-dimensional gas-liquid-solid reaction environment can be characterized by interconnected pores, gas diffusion channels, electrolyte-wetted catalyst surfaces, and electrically conductive pathways. Materials and structures can be selected to balance gas access, electrolyte wetting, catalytic active-site exposure, and electron transport.

As used herein, “hydrophilic-hydrophobic interface” generally refers to a region, boundary, gradient, or combination of adjacent regions having different wetting behavior with respect to aqueous electrolyte. A hydrophilic-hydrophobic interface can be formed by combining carbon paper, carbon cloth, fluoropolymer-treated gas diffusion media, untreated porous substrate, ionomer-containing catalyst layers, metal foam, wetting agents, hydrophobic binders, or surface treatments. Commercial examples include wet-proofed carbon paper and polytetrafluoroethylene-treated carbon cloth gas diffusion media. A hydrophilic-hydrophobic interface can be selected or tuned based on electrolyte leakage resistance, oxygen transport, electrolyte retention, and pressure differential across the gas diffusion layer.

As used herein, “annealing” generally refers to a thermal treatment performed under a selected atmosphere, temperature, and time to dry, decompose, oxidize, crystallize, alloy, adhere, or convert precursor material on a substrate. Annealing can be conducted in air, oxygen, nitrogen, argon, forming gas, vacuum, steam-containing atmosphere, or another controlled atmosphere. Annealing can be selected based on desired catalyst phase, oxidation state distribution, adhesion, crystallinity, porosity, and compatibility with the conductive porous substrate.

As used herein, “oxygen-containing gas” generally refers to a gas stream or gas environment including oxygen. An oxygen-containing gas can include ambient air, purified oxygen, oxygen-enriched air, humidified air, dry air, compressed air, or a mixture including oxygen and one or more inert or carrier gases. An oxygen-containing gas can be selected based on oxygen concentration, humidity, flow rate, pressure, carbon dioxide content, and intended operating environment.

### Zinc-air Batteries

As described herein, a zinc-air battery can have an integrated electrode architecture paired with an ultra-thin flowable catholyte. This configuration enhances oxygen capture from ambient air, thereby increasing the oxygen utilization efficiency and achieving high energy density. In some embodiments, by using an integrated electrode with an ultra-thin flowable cathode electrolyte, dissolved oxygen can be effectively captured based on fluid mechanics principles, resulting in an improved battery power density over other zinc-air batteries that do not have an electrode that can be integrated with the ultra-thin flowable catholyte.

Furthermore, the zinc anode of the zinc-air battery can be electrochemically deposited (e.g., during charging) onto a nickel or titanium mesh substrate, which contributes to improved power density and enhances cycling stability, thereby lowering the long-term operating and maintenance costs of the battery. In some embodiments, zinc can be deposited on a nickel or titanium mesh during charging, creating an in-situ zinc anode. This method enhances zinc utilization and offers high reversibility, supporting efficient energy storage and extended battery lifespan.

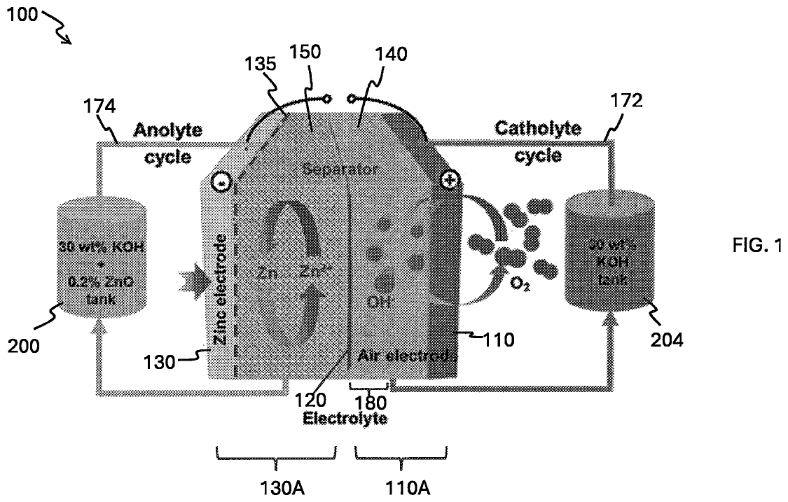

Turning now to FIG. 1, a zinc-air battery 100 includes a cathode compartment 110A, an anode compartment 130A, and a porous separator 120 positioned between the cathode compartment 110A and the anode compartment 130A. A cathode 110 is disposed in the cathode compartment 110A and is arranged to receive oxygen from ambient air. A flowable catholyte layer 140 is disposed between the cathode 110 and the porous separator 120 and includes potassium hydroxide, such as potassium hydroxide supplied from a potassium hydroxide tank 204. The flowable catholyte layer 140 provides ionic conductivity and a short transport path for dissolved oxygen adjacent to the cathode 110. In some embodiments, the flowable catholyte layer 140 is an ultra-thin flowable catholyte layer having a thickness of 1 micrometer to 4 micrometers. A zinc electrode 130 is disposed in the anode compartment 130A and is electrochemically deposited on a nickel or titanium mesh 135. An anolyte 150 is disposed in the anode compartment 130A and includes potassium hydroxide and zinc oxide, such as an aqueous solution including 30 weight percent potassium hydroxide and 0.2 weight percent zinc oxide supplied from an anolyte tank 200. A catholyte cycle 172 provides controlled flow of the flowable catholyte layer 140 to and from the cathode compartment 110A, and an anolyte cycle 174 provides controlled flow of the anolyte 150 to and from the anode compartment 130A.

During discharge of the zinc-air battery 100 shown in FIG. 1, oxygen from ambient air enters through the cathode 110 and is reduced at catalytic sites in communication with the flowable catholyte layer 140 to form hydroxide ions. The hydroxide ions migrate through the porous separator 120 into the anolyte 150, where zinc at the zinc electrode 130 is oxidized to form zincate species and electrons. During charging, zinc is redeposited on the nickel or titanium mesh 135 and oxygen is generated at the cathode 110. The nickel or titanium mesh 135 provides a conductive, porous support for zinc deposition and can promote uniform zinc plating and stripping during repeated charge-discharge cycles.

As shown in FIG. 1, the novel flowable type zinc-air battery includes an integrated cathode, a porous separator, and an anode based on zinc plating of a nickel or titanium mesh. An ultra-thin flowable catholyte layer 140 (including KOH from first tank 204) is maintained between a powder electrode 190 (located in the cathode compartment 110A) and separator 120 to facilitate oxygen absorption and electrochemical reduction. A self-supported electrode 180 is immersed in the flowable catholyte layer 140. On the opposing side of the separator 120, an anolyte 150 containing aqueous potassium hydroxide (KOH) and suspended zinc oxide (ZnO) circulates (from second tank 200) in contact with the nickel or titanium-supported zinc anode 130. The zinc-air battery 100 is contained in a battery housing (not shown) encloses these components and provides channels 172 and 174 for the controlled flow of catholyte and anolyte streams respectively.

During discharge, oxygen from ambient air enters the system through the air diffusion inlet 180 and is reduced at the cathode 110, which includes a catalyst layer supported on a gas diffusion medium. The oxygen reduction reaction (ORR) proceeds via the formation of hydroxide ions (OH-) in the ultra-thin flowable catholyte 140, as shown in Equation (1) below:

O₂+2H₂O+4^{e-}→4OH⁻ (1).

These hydroxide ions migrate through the porous separator 120 into the anolyte 150, where they participate in the oxidation of zinc at the anode 130, generating electrons and zincate ions (Zn(OH)₄²⁻), according to Equation (2):

Zn+4OH⁻→Zn(OH)₄²⁻+2e⁻ (2).

The electrons travel through an external circuit to provide electrical power. The zincate ions in the anolyte can gradually decompose to form solid ZnO and regenerate OH-ions, helping maintain ionic balance and system stability. During charging, the electrochemical reactions zinc is redeposited onto the nickel or titanium mesh 135 and oxygen is generated at the cathode.

The ultra-thin flowable catholyte 140 enables rapid oxygen diffusion and efficient ORR kinetics by minimizing the diffusion path length while maintaining strong ionic conductivity. The presence of KOH in both the catholyte and anolyte can be useful for providing a high-conductivity medium and supporting the solubility of zincate species. Both the anolyte and the catholyte are flowable, i.e., they are in liquid form and are transported to and from the storage tanks to the anode compartment and the cathode compartment respectively. In particular, KOH serves as the primary electrolyte facilitating charge transport and electrochemical reactions. The addition of ZnO to the anolyte pre-saturates the solution with zincate ions, reducing the solubility gradient and helping suppress excessive zinc dissolution, dendrite formation, and hydrogen evolution. This promotes more uniform zinc plating/stripping during cycling and stabilizes the anode interface.

The nickel or titanium mesh 135 functions as a stable current collector that enhances structural robustness, promotes uniform zinc deposition, and improves thermal and mass transport throughout the anode region. This configuration, integrating a highly reactive cathode, thin-layer electrolyte flows, and a robust zinc-plated anode substrate, enables high energy and power density, long cycle life, and efficient air utilization under ambient conditions.

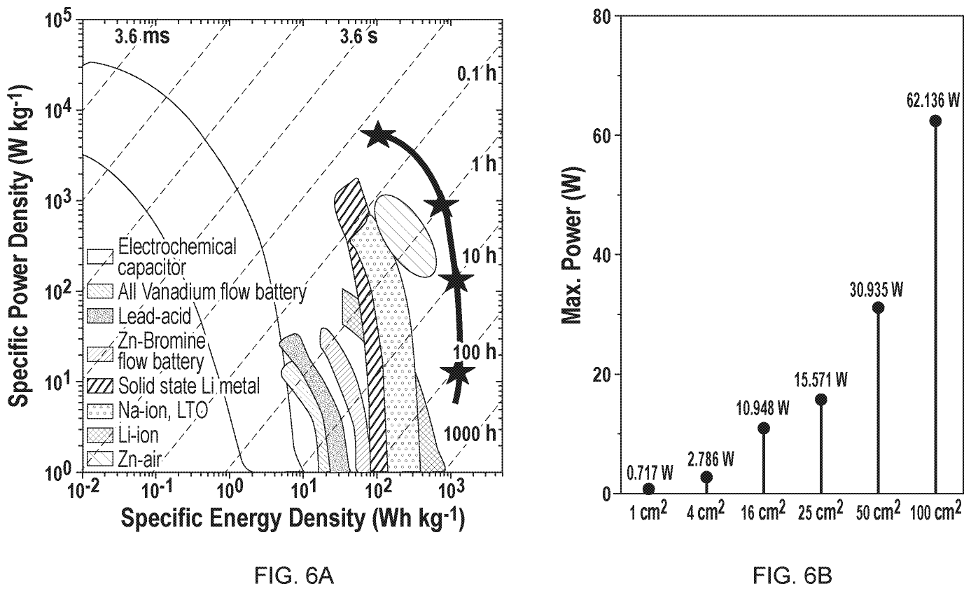

FIG. 6 shows cell level power density and energy density performance for a zinc-air battery. The performance data reflect the coupled effect of the integrated cathode architecture, the flowable catholyte layer, and the zinc electrode electrochemically deposited on the nickel or titanium mesh. In some embodiments, the zinc-air battery achieves a power density of about 700 mW/cm² to about 717 mW/cm². The flowable catholyte layer and the integrated cathode structure can improve oxygen utilization, reduce transport limitations, and reduce internal resistance, while the nickel or titanium mesh can stabilize zinc deposition in the anode compartment. The combined architecture thereby supports high power output and stable rechargeable operation.

### Self-Supporting Electrodes

Disclosed herein is an integrated electrode architecture that addresses the limitations of air electrodes used in metal-air batteries by combining a catalyst-rich gas diffusion layer (GDL) with a mechanically robust self-supporting electrode structure. The integrated electrode includes a GDL electrode portion formed from a finely dispersed powder catalyst composition and a self-supporting electrode portion to provide structural stability and electrical conductivity. In some embodiments, the GDL electrode portion includes a carbon paper with a powdered catalyst disposed thereon. The carbon paper with the powdered catalyst disposed thereon can be pressed into a porous metal substrate that has metallic powders of nickel, cobalt and manganese disposed thereon. The manganese can be the largest component of the metallic powders and can be present in an amount of greater than 50 wt %, based on a total weight of the metallic powders present on the porous metal substrate. In some embodiments, the porous metal substrate includes nickel metal.

In certain embodiments, the finely dispersed powder catalyst (disposed on the porous metal substrate) includes a manganese-based composition enriched in Mn(III) species. For example, the Mn(III) content can be greater than or equal to 50 atomic percent of the total manganese oxidation states. In some embodiments, the Mn(III) content can be greater than or equal to 55 atomic percent, greater than or equal to 60 atomic percent, greater than or equal to 65 atomic percent, greater than or equal to 70 atomic percent, greater than or equal to 75 atomic percent, or greater than or equal to 80 atomic percent of the total manganese oxidation states. This Mn(III) active site content promotes enhanced catalytic activity for an oxygen reduction reaction and an oxygen evolution reactions (ORR/OER), thereby improving both round-trip efficiency and energy density in rechargeable battery systems. The synergistic integration of the catalytic and structural elements in a monolithic electrode format leads to superior electrochemical performance and extended cycle life.

Electrodes prepared from powdered catalysts usually use polymer binders and additional conductive additives, which can result in uncontrolled microstructures, limited active surface areas, large dead volumes, and poor interfaces, which are detrimental to electronic conduction and mass transport of heterogeneous reactants/products. While self-supporting electrodes can address the challenges associated with powder electrodes, their drawbacks, such as susceptibility to leakage and a poor three-phase reaction interface, restrict their applicability in zinc-air batteries. The integrated electrode disclosed herein can not only fully utilize the advantages of powder electrodes and self-supporting electrodes, but also effectively avoid the limitations of these two electrodes, thereby exhibiting high catalytic activity, high power density, and high cycling stability. The high-performance cathode gives it an advantage in market competition. At the same time, our reproducible experiments verify that the integrated electrode can be adapted to industrial-scale preparation.

More specifically, the integrated electrode disclosed herein includes a powder (GDL) electrode (a carbon paper with catalytic powder disposed thereon) and a self-supporting substrate (the porous metal with the metallic catalyst powders disposed thereon). The advantages of the high catalytic loading (the Mn(III)) of the self-supporting electrode can be utilized to avoid the problems of high-load powder catalytic agglomeration and mass transfer limitation; on the other hand, the hydrophilic-hydrophobic interface constructed by the GDL electrode can be used to avoid the problem of leakage of the self-supporting electrode. Moreover, the integrated electrode contains abundant, highly stable Mn (III) active sites, which ensure rapid oxygen catalytic kinetics

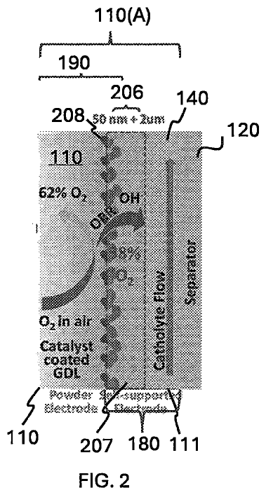

FIG. 2 is a schematic depiction of another exemplary embodiment of the ultra-thin flow catholyte layer 140 with the integrated cathode 110(A). The integrated cathode 110(A) includes a self-supported electrode 180 and a porous powder electrode 190. The porous powder electrode 190 includes a catalytic layer 206 (having powder catalyst particles disposed on a carbon fiber paper or carbon cloth) in communication with a porous metal substrate having metallic oxide powder particles disposed thereon 180. In some embodiments, the self-supported electrode 180 are immersed in a thin catholyte layer 140. The catholyte layer 140 contacts the separator 120. The porous powder electrode 190 (which is one part of the integrated cathode) includes a porous, electrically conductive substrate 110, such as carbon fiber paper or carbon cloth with catalytic metal oxide particles 208 disposed thereon. The carbon paper or carbon cloth serves as a gas diffusion medium. The catalytic layer 206 is in contact with a porous self-supported electrode 180 (that has nickel, cobalt and manganese oxide particles disposed thereon) to form the integrated cathode 110(A). The porous metal substrate 111 (such as Ni foam) is self-supporting and mechanically supports the GDL 206. In some embodiments, the three-phase reaction interface 207 is extended to 2.05 micrometers.

The GDL 206 can include a catalytic metal powder i.e., it is sometimes referred to as a powder electrode. The powder electrode can be in electrical communication with a current collector (not shown). One or more surfaces of the carbon fiber paper or carbon cloth can be coated with an electrocatalytic layer that includes an oxygen reduction reaction (ORR) catalyst, such as manganese oxide, cobalt oxide, silver, platinum, or other transition metal-based catalysts, optionally dispersed on a high-surface-area conductive support. The catalyst particles 208 can be held together by an ion-conducting binder (not shown), such as an anion exchange polymer or perfluorosulfonic acid ionomer, to enhance ionic transport between the catalyst surface and the catholyte 140. The conductive substrate 110 facilitates the transport of oxygen from ambient air to the catalyst interface while maintaining electrical conductivity and structural stability. Simultaneously, the catalyst particles 208 promotes the efficient electrochemical reduction of oxygen to hydroxide ions during discharge operation in an alkaline environment.

In certain embodiments, the finely dispersed powder catalyst (disposed on the porous metal substrate) includes a manganese-based composition enriched in Mn(III) species, with the Mn(III) content including up to 50 atomic percent of the total manganese oxidation states. This Mn(III) active site content promotes enhanced catalytic activity for an oxygen reduction reaction and an oxygen evolution reactions (ORR/OER), thereby improving both round-trip efficiency and energy density in rechargeable battery systems. The synergistic integration of the catalytic and structural elements in a monolithic electrode format leads to superior electrochemical performance and extended cycle life.

Electrodes prepared from powdered catalysts usually use polymer binders and additional conductive additives, which can result in uncontrolled microstructures, limited active surface areas, large dead volumes, and poor interfaces, which are detrimental to electronic conduction and mass transport of heterogeneous reactants/products. While self-supporting electrodes can address the challenges associated with powder electrodes, their drawbacks, such as susceptibility to leakage and a poor three-phase reaction interface, restrict their applicability in zinc-air batteries. The integrated electrode disclosed herein can not only fully utilize the advantages of powder electrodes and self-supporting electrodes, but also effectively avoid the limitations of these two electrodes, thereby exhibiting high catalytic activity, high power density, and high cycling stability. The high-performance cathode gives it an advantage in market competition. At the same time, our reproducible experiments verify that the integrated electrode can be adapted to industrial-scale preparation.

The integrated electrode disclosed herein includes a powder (GDL) electrode (a carbon paper with catalytic powder disposed thereon) and a self-supporting substrate (the porous metal with the metallic catalyst powders disposed thereon). The advantages of the high catalytic loading (the Mn(III)) of the self-supporting electrode can be utilized to avoid the problems of high-load powder catalytic agglomeration and mass transfer limitation; on the other hand, the hydrophilic-hydrophobic interface constructed by the GDL electrode can be used to avoid the problem of leakage of the self-supporting electrode. Moreover, the integrated electrode contains abundant, highly stable Mn (III) active sites, which ensure rapid oxygen catalytic kinetics

Referring again to FIG. 2, the cathode compartment 110A includes a gas diffusion layer 190, a catalytic layer 206, catalyst particles 208, a catholyte flow 140, the porous separator 120, and a self-supported electrode 180 including a porous metal substrate 111. The gas diffusion layer 190 includes carbon fiber paper or carbon fiber cloth and transports oxygen from ambient air toward the catalytic layer 206 while providing electrical conductivity. The catalyst particles 208 are disposed on the gas diffusion layer 190 and can include manganese oxide, cobalt oxide, silver, platinum, another transition metal-based catalyst, or a combination thereof. In some embodiments, the catalyst particles 208 are dispersed on a high-surface-area conductive support and are held on the gas diffusion layer 190 by an ion-conducting binder.

The self-supported electrode 180 shown in FIG. 2 includes the porous metal substrate 111 and catalytic material directly grown on the porous metal substrate 111. In some embodiments, the porous metal substrate 111 includes nickel foam, and the catalytic material includes nickel, cobalt, and manganese. In some embodiments, manganese in the catalytic material is enriched in Mn(III), such that Mn(III) is present as a predominant manganese species based on manganese species present in the catalytic material. The self-supported electrode 180 can be binder-free and defines open gas diffusion channels and continuous electron pathways. The gas diffusion layer 190 can be pressed against the self-supported electrode 180 to form an integrated cathode structure in which the advantages of a powder catalyst electrode and a self-supported electrode are combined. The catholyte flow 140 contacts the self-supported electrode 180 and the porous separator 120, thereby providing a three-phase reaction interface 207 where gas, liquid electrolyte, and solid catalytic material are brought into contact. The three-phase reaction interface 207 can extend through the porous structure of the self-supported electrode 180 to form a three-dimensional gas-liquid-solid reaction environment.

### Methods of Manufacturing the Self-supporting Electrodes and Zinc-air Batteries

In various embodiments, disclosed herein is a method of manufacturing a zinc-air battery, the method including disposing an ultra-thin flowable catholyte layer that includes KOH between an air cathode and a porous separator; and disposing a flowable anolyte that includes KOH and ZnO between a nickel or titanium mesh and the separator; and electrochemically disposing a zinc anode onto a conductive nickel or titanium mesh.

Disclosed herein too is a method of manufacturing the integrated electrode. The integrated electrode can be manufactured by taking a porous metal substrate and coating it with salts of catalytic metals. Catalytic metal oxides can also be disposed on the substrate in lieu of or in combination with the metal salts. The salts can include nickel salts, cobalt salts, manganese salts, or a combination thereof. Carbonaceous particles such as carbon black, carbon nanotubes, carbon fibers, graphite particles, graphene, or the like, or a combination thereof can be added to the catalytic metal salts. The metal salts and the carbonaceous particles can be dispersed in a solution. The solution can facilitate the dissolution of the metal salts. The porous metal substrate can be dipped into the solution, withdrawn from the solution and subjected to drying. It can be then subjected to annealing at an elevated temperature of 200 to 300C to convert the metal salt to a catalytic metal. An appropriate reactive or reducing environment can be used to facilitate a conversion of the metal salts to a metal.

The gas diffusion layer can be prepared by taking carbon paper or carbon cloth and disposing catalytic metal particles and/or metal oxide (in powder form) on the surface of the carbon fiber paper and/or cloth. The catalyst particles are held together by an ion-conducting binder (not shown), such as an anion exchange polymer or perfluorosulfonic acid ionomer. The gas diffusion layer can be then pressed to the porous metal substrate to form the integrated electrode. In some embodiments, the integrated electrode can be used as a cathode (and can be therefore referred to as an integrated cathode).

Disclosed herein too is a method of manufacturing a zinc-air battery. The method including charging an ultra-thin flowable catholyte layer that includes KOH between an air cathode and the porous separator. A flowable anolyte that includes KOH and ZnO can be simultaneously charged between a nickel or titanium mesh and the separator. A zinc anode can be disposed onto a conductive nickel or titanium mesh.

### Methods of Using the Zinc-air Batteries

In some embodiments, disclosed herein is a method of using a zinc-air battery, the method including charging a flowable anolyte including KOH and ZnO into the zinc-air battery between a nickel or titanium mesh and a separator; simultaneously charging a flowable catholyte including KOH into the zinc-air battery between the separator and an air cathode; electrochemically disposing a zinc anode onto a conductive nickel or titanium mesh; and generating an electrical current.

Disclosed herein too is a method of using a zinc-air battery. The method includes charging a flowable anolyte including KOH and ZnO into the zinc-air battery between a nickel or titanium mesh and the separator. A flowable catholyte including KOH can be simultaneously charged into the zinc-air battery between the separator and the integrated cathode. Zinc can be electrochemically disposed onto the conductive nickel or titanium mesh while generating an electrical current in the zinc-air battery. Disclosed herein is an integrated electrode architecture that addresses the limitations of air electrodes used in metal-air batteries by combining a catalyst-rich gas diffusion layer (GDL) with a mechanically robust self-supporting electrode structure. The integrated electrode includes a GDL electrode portion formed from a finely dispersed powder catalyst composition and a self-supporting electrode portion to provide structural stability and electrical conductivity. In some embodiments, the GDL electrode portion includes a carbon paper with a powdered catalyst disposed thereon. The carbon paper with the powdered catalyst disposed thereon can be pressed into a porous metal substrate that has metallic powders of nickel, cobalt and manganese disposed thereon. The manganese can be the largest component of the metallic powders and can be present in an amount of greater than 50 wt %, based on a total weight of the metallic powders present on the porous metal substrate. In some embodiments, the porous metal substrate includes nickel metal.

For reasons of completeness, various aspects for the disclosure are set out in the following numbered clauses, intending to include text from the applications to which the present disclosure claims priority.

Clause 1. An integrated cathode, the cathode including a gas diffusion layer, the gas diffusion layer including a powder fiber paper or cloth upon which are disposed catalytic metal and/or metal oxide particles; and a porous metal substrate upon which are disposed a plurality of catalytic metal particles, where the catalytic metal particles contain nickel, cobalt and manganese, and where the manganese (III) for of manganese can be present in the largest amount based on the manganese species present in the catalytic metal particles; and where the gas diffusion layer can be pressed to the porous metal substrate.

Clause 2. A zinc-air battery including an anode compartment; where the anode compartment includes an anode and an anolyte; a separator; and a cathode compartment; where the cathode compartment includes a cathode and a catholyte; where the cathode is the integrated cathode of Claim 1.

Clause 3. A method of manufacturing an integrated cathode, including disposing on a porous metal substrate metal oxides, salts of catalytic metals, or a combination thereof; annealing the porous metal substrate to reduce the salts of catalytic metals to a catalytic metal; disposing on a carbon fiber paper or carbon fiber cloth catalytic metal oxide or catalytic metal particles to form a gas diffusion layer; and pressing the gas diffusion layer onto the porous metal substrate.

Clause 4. A zinc-air battery including an integrated electrode architecture paired with an ultra-thin flowable catholyte as described herein; and a zinc anode electrochemically deposited onto a nickel or titanium mesh substrate.

Clause 5. A zinc-air battery including a layered structure including an air cathode; a porous separator; a zinc anode electrochemically deposited onto a conductive nickel or titanium mesh; where the air cathode includes an ultra-thin flowable catholyte layer including KOH disposed between the cathode and the porous separator to facilitate oxygen absorption and electrochemical reduction; and where the zinc anode contacts an anolyte including KOH and ZnO.

Clause 6. A method of manufacturing a zinc-air battery, the method including disposing an ultra-thin flowable catholyte layer that includes KOH between an air cathode and a porous separator; and disposing a flowable anolyte that includes KOH and ZnO between a nickel or titanium mesh and the separator; and electrochemically disposing a zinc anode onto a conductive nickel or titanium mesh.

Clause 7. A method of using a zinc-air battery, the method including charging a flowable anolyte including KOH and ZnO into the zinc-air battery between a nickel or titanium mesh and a separator; simultaneously charging a flowable catholyte including KOH into the zinc-air battery between the separator and an air cathode; electrochemically disposing a zinc anode onto a conductive nickel or titanium mesh; and generating an electrical current.

In addition, in some embodiments, a computer program product is provided. The computer program product can be stored on non-transitory machine readable media and include instructions for implementing methods. The methods can provide for control of equipment (such as that which is disclosed herein as well as a variety of other functionally related equivalents), communications, user-interaction, input and output, calculations and estimations, and other functions as set forth herein.

### EXAMPLES

### Example 1

This example was conducted to demonstrate the manufacturing of the integrated cathode for use in a zinc-air battery. The integrated cathode included a nickel foam on which particles of cobalt, nickel and manganese oxide were deposited. This is termed a “coated nickel foam. The Mn(III) was present in an amount of greater than 50 atomic percent of the total manganese oxidation states. A gas diffusion layer including carbon paper with a powder catalyst disposed thereon was then pressed into the coated nickel foam to form the integrated cathode.

The nickel foam (portion of the integrated cathode) was synthesized via a hydrothermal method. Cobalt (II) acetate tetrahydrate and nickel acetate tetrahydrate in a 1:1 molar ratio were added to a certain amount of a 25 to 28 wt % ammonia solution to form a first transition metal solution. The 25 to 28 wt % ammonia solution has a molality of 13.36~14.96 mol/L. An as-prepared mixture of manganese oxide (MnO₂) and carbon nanotubes (CNTs) in a 1:1 molar ratio of was added to the first transition metal solution and subjected to 30 minutes of ultrasonic agitation to form a uniform wet mixture.

A nickel foam was then cleaned using ultrasonic agitation for 30 minutes in a solution including 0.1 M hydrochloric acid (HCl), deionized water and ethanol in order to remove an oxide-containing surface layer and residual oil/organic contaminants from the surface of the nickel foam. The uniform wet mixture and the clean Ni foam were transported to an autoclave where they were maintained at a temperature of 160 °C for 6 hours. The self-supporting electrode (the clean nickel foam) and powdered catalyst were washed with deionized water and ethanol. This was followed by drying in a vacuum oven at 70 °C for 8 hours. Finally, the resulting product (the nickel foam coated with nickel, cobalt and manganese salts) (also referred to as a “self-supporting electrode”) was further calcined in air at 350 °C for 1 hour to obtain a powder coated nickel foam.

The GDL electrode (which is bonded to the powder coated nickel foam) was then prepared by spraying the power catalyst (with a loading of 2 mg cm^{31 2}) onto a carbon paper. Finally, the self-supporting electrode and the GDL electrode were mechanically pressed to form the integrated electrode.

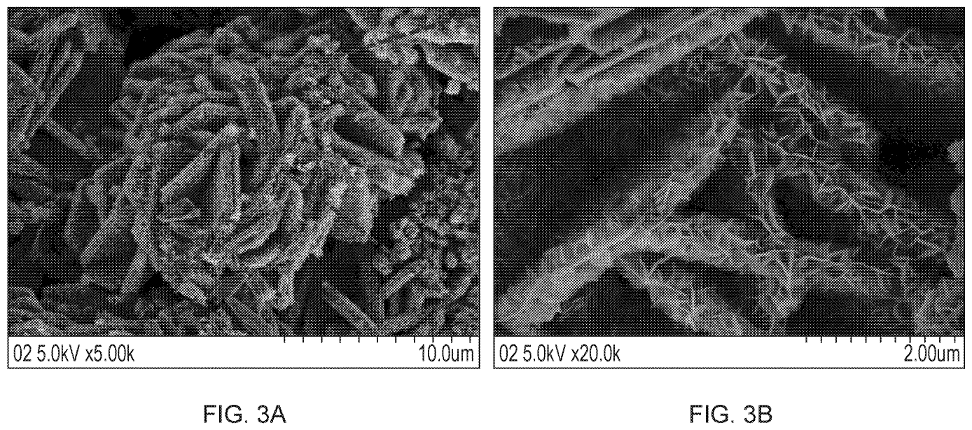

FIG. 3 depicts scanning electron microscopic (SEM) photomicrographs of the integrated cathode at different magnifications (A) at a magnification of 5000X; and (B) at a magnification of 20,000X. The images illustrate the surface morphology of the integrated cathode, including catalytic material distributed on and within the porous structure of the self-supported electrode. The morphology shown in FIG. 3 provides exposed active sites and interconnected pores for gas transport, electrolyte access, and electron conduction. The porous structure can reduce blocked or inactive regions relative to binder-containing powder electrodes and can support mechanical robustness of the integrated cathode.

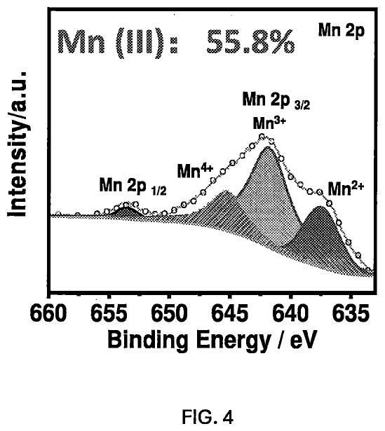

FIG. 4 depicts a wide angle x-ray spectrum showing the presence of Mn (III) diffraction peaks. That is, FIG. 4 shows spectroscopic data corresponding to manganese oxidation states in the catalytic material of the integrated cathode. The data include features associated with Mn 2p1/2 and Mn 2p3/2 regions and with Mn2+, Mn3+, and Mn4+ species. The relative signal contribution of Mn(III) indicates that the catalytic material is enriched in Mn(III), which provides active manganese sites for oxygen electrocatalysis. The Mn(III)-enriched composition can tune electronic structure of the catalytic material and support catalytic activity for both oxygen reduction and oxygen evolution.

### Example 2

This example was conducted to demonstrate electrochemical measurements on a half-cell system that uses the integrated cathode detailed in Example 1. Linear scanning voltammetry (LSV) and electrochemical impedance spectroscopy (EIS) were performed in a standard half-cell system using Solartron 1470E Multistat and 1255B Frequency Response Analyzer (Solartron Analytical, Oak Ridge, TN, 37830) with Ag/AgCl electrode as the reference electrode, platinum (Pt) wire as the counter electrode, and the integrated cathode as working electrode. 0.1 M KOH was used as the electrolyte. Ultra-high purity oxygen gas and nitrogen gas were bubbled in the electrolyte for 1 hour before each test. LSV was obtained in O₂-saturated and N₂-saturated electrolyte at 5 mV s⁻¹ with the potential range for −0.8 V to 1 V vs. Ag/AgCl, respectively.

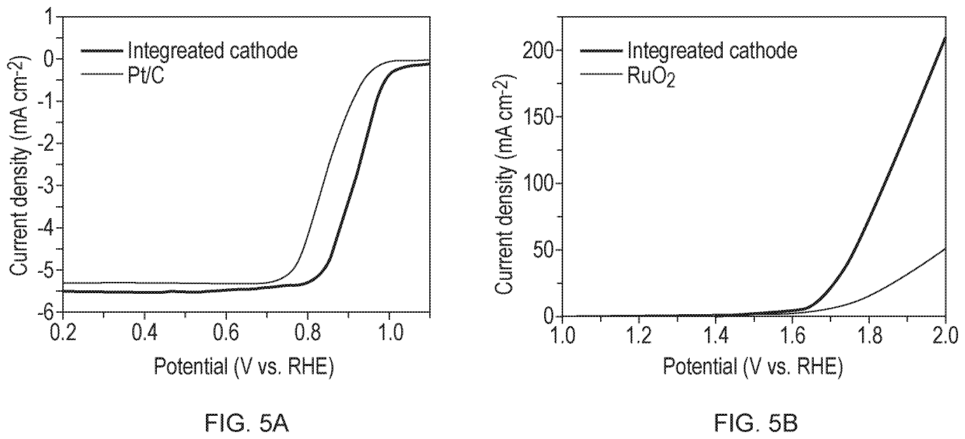

FIG. 5 shows electrochemical performance of the integrated cathode compared with noble metal catalyst references including Pt/C and RuO₂. The electrochemical performance includes oxygen reduction reaction performance and oxygen evolution reaction performance measured using linear sweep voltammetry. The oxygen reduction reaction data characterize discharge-related catalytic activity, and the oxygen evolution reaction data characterize charge-related catalytic activity. The integrated cathode provides bifunctional oxygen electrocatalytic activity by combining Mn(III)-enriched catalytic sites, conductive pathways through the porous metal substrate, and reactant access through the gas diffusion layer and catholyte flow.

Unless defined otherwise, all technical and scientific terms used herein have the same meaning as commonly understood by one of ordinary skill in the art to which this invention belongs. The abbreviations used herein have their conventional meaning within the chemical and arts.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a method described herein can be combined in a variety of ways without departing from the spirit and scope of the present invention, whether explicit or implicit herein. For example, where reference is made to a particular compound, that compound can be used in various embodiments of compositions of the present invention and/or in methods of the present invention, unless otherwise understood from the context. In other words, within this application, embodiments have been described and depicted in a way that enables a clear and concise application to be written and drawn, but it is intended and will be appreciated that embodiments can be variously combined or separated without parting from the present teachings and invention(s). For example, it will be appreciated that all features described and depicted herein can be applicable to all aspects of the invention(s) described and depicted herein.

In other words, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components can be included and called upon for providing for aspects of the teachings herein. For example, additional materials, combinations of materials and/or omission of materials can be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure herein of any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Accordingly, any means which can provide those functionalities can be regarded as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. By way of example, “an element” means one element or more than one element. Similarly, the adjective “another,” when used to introduce an element, is intended to mean one or more elements.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Where the use of the term “about” is before a quantitative value, the present invention also includes the specific quantitative value itself, unless specifically stated otherwise. As used herein, the term “about” refers to a ±10% variation, a ±5% variation, or a ±2.5% variation from the nominal value as understood from the context, unless otherwise indicated or inferred from the context.

At various places in the present specification, values are disclosed in groups or in ranges. It is specifically intended that the description include each and every individual sub-combination of the members of such groups and ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as” or “including,” is intended merely to illustrate better the present invention and does not pose a limitation on the scope of the invention unless claimed. The term “exemplary” is not intended to be construed as a superlative example but merely one of many possible examples. The examples provided herein are intended solely for illustrative purposes and are not to be interpreted as restricting the disclosed subject matter to the specific embodiments presented. No language in the specification should be construed as indicating any non-claimed element as essential to the practice of the present invention.

Throughout the description, where compositions and kits are described as having, including, or including specific components, or where processes and methods are described as having, including, or including specific steps, it is contemplated that, additionally, there are compositions and kits of the present invention that consist essentially of, or consist of, the recited components, and that there are processes and methods according to the present invention that consist essentially of, or consist of, the recited processing steps.

As a general matter, compositions specifying a percentage are by weight unless otherwise specified.

Any particular embodiment of the present teachings that falls within the prior art can be explicitly excluded from any one or more of the claims. Because such embodiments are deemed to be known to one of ordinary skill in the art, they can be excluded even if the exclusion is not set forth explicitly herein. Any particular embodiment of the disclosure can be excluded from any claim, for any reason, whether or not related to the existence of prior art.

The disclosure can be embodied in other specific forms without departing from the spirit or essential characteristics thereof. The foregoing embodiments are therefore to be considered in all respects illustrative rather than limiting the disclosure described herein. Scope of the disclosure is thus indicated by the appended claims rather than by the foregoing description, and all changes that come within the meaning and range of equivalency of the claims are intended to be embraced therein.

What is claimed is:

1. A zinc-air flow battery comprising:
a battery housing defining a cathode compartment and an anode compartment;
a porous separator positioned between the cathode compartment and the anode compartment;
an integrated cathode disposed in the cathode compartment, the integrated cathode comprising a conductive porous substrate and a catalyst directly grown on the conductive porous substrate such that the integrated cathode is self-supported and binder-free, wherein the catalyst comprises nickel, cobalt, and manganese and wherein Mn(III) is present as a predominant manganese species based on manganese species present in the catalyst;
a gas diffusion layer pressed against the conductive porous substrate, the gas diffusion layer comprising carbon fiber paper and/or carbon fiber cloth and catalytic metal particles and/or catalytic metal oxide particles disposed on the carbon fiber paper and/or the carbon fiber cloth;
a flowable catholyte comprising KOH disposed in the cathode compartment between the integrated cathode and the porous separator, wherein the flowable catholyte and the integrated cathode define a three-dimensional gas-liquid-solid reaction environment;
a nickel mesh current collector disposed in the anode compartment;
a flowable anolyte comprising KOH and ZnO disposed in the anode compartment and in contact with the nickel mesh current collector; and
a zinc anode electrochemically deposited on the nickel mesh current collector.

2. The zinc-air flow battery of claim 1, wherein the conductive porous substrate comprises nickel foam.

3. The zinc-air flow battery of claim 1, wherein the catalyst comprises nickel oxide, cobalt oxide, and manganese oxide.

4. The zinc-air flow battery of claim 1, wherein the Mn(III) is present in an amount greater than 50 atomic percent based on total manganese oxidation states present in the catalyst.

5. The zinc-air flow battery of claim 1, wherein the catalyst comprises manganese in an amount greater than 50 weight percent based on a total weight of nickel, cobalt, and manganese present in the catalyst.

6. The zinc-air flow battery of claim 1, wherein the flowable catholyte has a thickness of 1 micrometer to 4 micrometers.

7. The zinc-air flow battery of claim 1, wherein the nickel mesh current collector has a thickness of 50 micrometers to 500 micrometers, an average pore size of 50 micrometers to 400 micrometers, and a porosity of 45 volume percent to 75 volume percent based on a total volume of the nickel mesh current collector.

8. The zinc-air flow battery of claim 1, wherein the battery housing defines a catholyte channel to provide controlled flow of the flowable catholyte and an anolyte channel to provide controlled flow of the flowable anolyte.

9. The zinc-air flow battery of claim 1, wherein the catalytic metal particles and/or catalytic metal oxide particles comprise at least one of manganese oxide, cobalt oxide, silver, platinum, and another transition metal-based catalyst.

10. The zinc-air flow battery of claim 1, wherein the gas diffusion layer defines a hydrophilic-hydrophobic interface to reduce leakage through the conductive porous substrate.

11. An integrated cathode for a zinc-air flow battery, the integrated cathode comprising:
a conductive porous substrate defining open gas diffusion channels;
a catalyst directly grown on the conductive porous substrate such that the integrated cathode is self-supported and binder-free, wherein the catalyst comprises nickel, cobalt, and manganese and wherein Mn(III) is present as a predominant manganese species based on manganese species present in the catalyst; and
a gas diffusion layer pressed against the conductive porous substrate, the gas diffusion layer comprising carbon fiber paper and/or carbon fiber cloth and catalytic metal particles and/or catalytic metal oxide particles disposed on the carbon fiber paper and/or the carbon fiber cloth.

12. The integrated cathode of claim 11, wherein the conductive porous substrate comprises nickel foam.

13. The integrated cathode of claim 11, wherein the catalyst comprises nickel oxide, cobalt oxide, and manganese oxide.

14. The integrated cathode of claim 11, wherein the Mn(III) is present in an amount greater than 50 atomic percent based on total manganese oxidation states present in the catalyst.

15. The integrated cathode of claim 11, wherein the catalyst comprises manganese in an amount greater than 50 weight percent based on a total weight of nickel, cobalt, and manganese present in the catalyst.

16. The integrated cathode of claim 11, wherein the catalytic metal particles and/or catalytic metal oxide particles comprise at least one of manganese oxide, cobalt oxide, silver, platinum, and another transition metal-based catalyst.

17. The integrated cathode of claim 11, wherein the catalytic metal particles and/or catalytic metal oxide particles are dispersed on a high-surface-area conductive support.

18. The integrated cathode of claim 11, wherein the gas diffusion layer comprises an ion-conducting binder holding the catalytic metal particles and/or catalytic metal oxide particles on the carbon fiber paper and/or the carbon fiber cloth.

19. The integrated cathode of claim 11, wherein the catalyst directly grown on the conductive porous substrate forms a three-dimensional architecture having exposed active sites and continuous electron pathways through the conductive porous substrate.

20. An electrochemical storage system comprising a zinc-air battery, the zinc-air battery comprising:
a battery housing defining a cathode compartment and an anode compartment;
a porous separator positioned between the cathode compartment and the anode compartment;
an integrated cathode disposed in the cathode compartment, the integrated cathode comprising a conductive porous substrate and a catalyst directly grown on the conductive porous substrate such that the integrated cathode is self-supported and binder-free, wherein the catalyst comprises nickel, cobalt, and manganese and wherein Mn(III) is present as a predominant manganese species based on manganese species present in the catalyst;
a gas diffusion layer pressed against the conductive porous substrate, the gas diffusion layer comprising carbon fiber paper and/or carbon fiber cloth and catalytic metal particles and/or catalytic metal oxide particles disposed on the carbon fiber paper and/or the carbon fiber cloth;
a flowable catholyte comprising KOH disposed in the cathode compartment between the integrated cathode and the porous separator, wherein the flowable catholyte and the integrated cathode define a three-dimensional gas-liquid-solid reaction environment;
a nickel mesh current collector disposed in the anode compartment;
a flowable anolyte comprising KOH and ZnO disposed in the anode compartment and in contact with the nickel mesh current collector; and
a zinc anode electrochemically deposited on the nickel mesh current collector, wherein the electrochemical storage system is used for one or more of electrochemical energy storage, renewable energy generation and storage, grid-scale energy storage, microgrid energy storage, backup power, distributed power systems, transportation electrification, industrial power management, telecommunications power systems, and stationary battery manufacturing.
